(19) United States
(12) Patent Application Publication
(10) Pub. No.: US 2015/0053639 A1
(43) Pub. Date: Feb. 26, 2015

(54) METHOD OF MANUFACTURING TOUCH DEVICES

(71) Applicant: Chih-Chung Lin, Taipei City (TW)

(72) Inventor: Chih-Chung Lin, Taipei City (TW)

(21) Appl. No.: 13/973,977

(22) Filed: Aug. 22, 2013

(51) Int. Cl. G06F 3/045

(52) U.S. Cl. CPC G06F 3/045
USPC 216/19

(57) ABSTRACT

A method of manufacturing touch devices comprises the steps of cutting a large-sized substrate into a plurality of even units and then performing the subsequent machining processes, providing the required materials of each structure layer, layer by layer, via sputtering or coating, and then simultaneously forming each structure layer via processes such as photolithography, developing, and etching. Therefore, the manufacturing cost is significantly reduced and the structure strength is substantially enhanced.

### BACKGROUND OF THE INVENTION

1. Field of the Invention

The present invention relates to a method of manufacturing touch devices and in particular to a method of manufacturing touch devices, which significantly reduces the manufacturing cost and substantially enhances the structure strength.

2. Description of Prior Art

With the industry increasingly advancing, the digitalized tools such as mobile phones, personal digital assistants, notebooks, and planet computers show the trend towards convenience, multifunction and aesthetics.

However, the displays as man-machining communication interfaces are dispensable to the mobile phones, personal digital assistants, notebooks, and planet computers. It is a great convenience for the users to operate the displays of the above products, in which most displays are the LCD displays as a mainstream.

Recently, with fast developing and application of information technology, mobile communication, and information appliances, for purposes of convenience, compact design, and more humanization, the input devices of many information products, such as the traditional keyboard and mouse, have been changed to the touch panel as the input device, in which the capacitive touch LCD display is currently the most popular.

The above touch LCD display is referred to the touch panel herein. The touch panel is a layered structure including the structures of glass substrate, touch electrode layer, mask layer, electrode path layer, insulated layer, and passivation layer. The above layers are stacked one another to form a layered structure. The glass substrate has a touch area and a non-touch area. The touch electrode layer is coated on the touch area of the glass substrate mainly via sputtering and then the touch electrodes are formed via photolithography, developing, and etching processes. After that, the mask layer is printed on the non-touch area of the substrate via ink printing. Next, the above electrode path layer is coated on the mask layer via sputtering and then the electrode path is formed via lithography, developing, and etching processes. Then, the insulated ink is printed at the extending ends of the touch electrodes of the masked area and at the non-corresponding electrode paths via ink printing to prevent a short circuit between the extending ends of the touch electrodes and the non-corresponding electrode paths. Finally, the passivation layer is coated on the above glass substrate, touch electrode layer, mask layer, electrode path layer, and insulated layer via coating. The traditional method of manufacturing touch panels forms touch electrodes and electrode paths via sputtering, lithography, developing, and etching processes, which incurs a considerable mask cost and time-consuming sputtering process. Thus, the traditional manufacturing process of touch panels suffers from considerable cost and manufacturing time.

In addition, during the traditional manufacturing process of touch panels, a large-sized substrate is processed with the abovementioned manufacturing processes and then is cut, easily resulting in insufficient strength around the perimeter of the cut substrate, which can not be reinforced further by any method.

Further, the traditional makers perform various manufacturing processes on the large-sized substrate first and then cut it into final products with desired size. After that, other machining is performed for the final products. Because the large-sized substrate is used and requires larger manufacturing tools, the expensive equipment causes higher manufacturing cost.

### SUMMARY OF THE INVENTION

Thus, to overcome the disadvantages of the traditional technology, the primary objective of the present invention is to provide a method of manufacturing touch devices, which significantly reduce the manufacturing cost.

Another objective of the present invention is to provide a method of manufacturing touch devices, which can enhance the structure strength.

To achieve the above objectives, the present invention provides a method of manufacturing touch devices including the steps of:

providing a substrate and cutting the substrate into a plurality of even units;

modifying an edge of each of the units via mechanical machining;

strengthening a surface the each of the units;

defining a touch area and a non-touch area on the surface of the each of the units and disposing a mask layer on the non-touch area;

disposing a touch electrode layer having a plurality of touch electrodes on the touch area and the non-touch area of the each of the units;

covering the touch electrode layer with a metal mask, forming a upper metal path layer on a part uncovered by the metal mask on the non-touch area, and then removing the metal mask;

forming the touch electrodes on the touch electrode layer and forming a plurality of upper metal paths on the upper metal path layer via processes including an etching process;

disposing an insulated layer on junctions of the touch electrodes and the upper metal paths, the insulated layer reserving a plurality of electrical connecting holes;

disposing a lower metal path layer having a plurality of lower metal paths on the insulated layer, electrically connecting the upper metal paths and the touch electrodes via the electrical connecting holes, and electrically connecting the upper metal paths and the lower metal paths via electrical connecting holes; and

disposing a passivation layer on the touch electrode layer, the lower metal path layer, and the insulated layer.

By means of the method of manufacturing touch devices of the present invention, the manufacturing cost can be significantly reduced. Also, the substrate is first cut into a plurality of even units, then a grinding machining can be performed on the edge of each of the units to diminish edge defect and residual stress, and finally the strength of the unit can be enhanced via physical or chemical treatment. Therefore, besides the manufacturing cost reduction, the method of manufacturing touch devices of the present invention can further enhance the strength of the substrate.

### BRIEF DESCRIPTION OF DRAWING

FIG. 1 is a manufacturing process of the method of manufacturing touch devices according to the first embodiment of the present invention; and

FIG. 2 is a manufacturing process of the method of manufacturing touch devices according to the second embodiment of the present invention.

### DETAILED DESCRIPTION OF THE INVENTION

The above objectives of the present invention and the features of structure and function of the present invention are described according to preferred embodiments in figures.

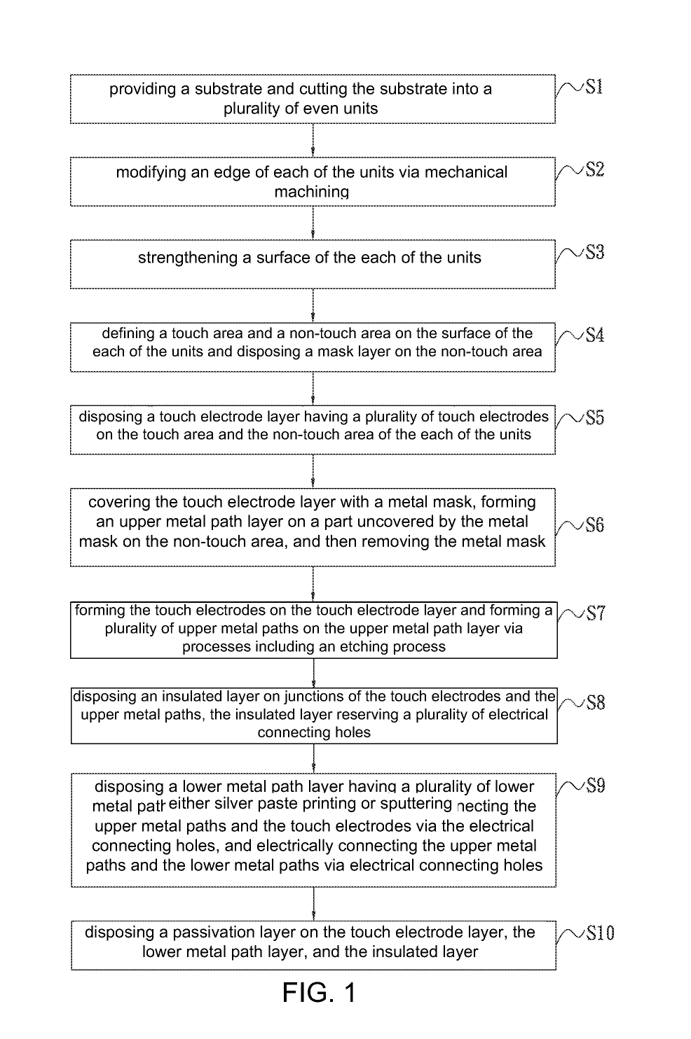

Please refer to FIG. 1, which is the manufacturing process of the method of manufacturing touch devices according to the first embodiment of the present invention. As shown in FIG. 1, the method of manufacturing the touch devices comprises the steps of:

S1: providing a substrate and cutting the substrate into a plurality of even units.

That is, a substrate whose material may be either transparent glass or transparent polymer is provided. The substrate is cut into a plurality of even units via mechanical machining. The size of the cut unit ranges from 7 inches to 13.3 inches.

S2: modifying an edge of each of the units via mechanical machining.

Via mechanical machining, the edge of the cut unit is modified to diminish edge defect and residual stress, which enhances the structure strength. The mechanical machining is, for example, grinding machining.

S3: strengthening a surface of the each of the units.

Chemical ion exchange solution is used to chemically strengthen the surface of the unit or quenching is used to physically strengthen the surface of the unit. Thus, the structure strength of the unit can be increased.

S4: defining a touch area and a non-touch area on the surface of the each of the units and disposing a mask layer on the non-touch area.

On the each unit processed with the previous steps, a touch area and a non-touch area are defined. The touch area is located at the center of the each unit. The non-touch area is defined as the area outside the touch area. A mask layer is formed on the non-touch area via ink coating which is either screen printing or lithography.

S5: disposing a touch electrode layer having a plurality of touch electrodes on the touch area and the non-touch area of the each of the units.

Via sputtering, the touch electrode layer is formed on the touch area and the non-touch area of the each of the units. The material of the touch electrode layer is selected from the group consisting of indium tin oxide (ITO), indium zinc oxide, zinc indium tin oxide, hafnium oxide, zinc oxide, aluminum oxide, aluminum tin oxide, aluminum tin oxide, cadmium tin oxide, and cadmium zinc cadmium oxide.

S6: covering the touch electrode layer with a metal mask, forming an upper metal path layer on a part uncovered by the metal mask on the non-touch area, and then removing the metal mask.

A metal mask is placed on the units and covers the touch areas. In the place where the metal mask covers the non-touch area, an upper metal path layer is directly formed on the top of the non-touch area corresponding to the mask layer via sputtering. Via photolithography and developing processes, the layout is completed in the upper metal path layer and the electrode circuit layer of the touch area undergoes the exposure and developing processes simultaneously.

S7: forming the touch electrodes on the touch electrode layer and forming a plurality of upper metal paths on the upper metal path layer via processes including an etching process.

The etchant for the upper metal path layers is selected from the group consisting of phosphate, nitric acid, acetic acid, and water.

In the process of etching the touch electrode layer, a plurality of touch electrodes on the touch area. The etchant for the touch electrode layer is selected from the group consisting of nitric acid, hydrochloric acid, and water.

The inorganic material is selected from the group consisting of silicon oxide, silicon nitride, silicon oxynitride, silicon carbide, hafnium oxide, and aluminum oxide.

The organic material is selected from the group consisting of photo resist, benzocyclobutene, ring vinyl, polyester, polyalcohol, polyethylene oxide, polyphenylene, resin, polyether, and polyketide.

S8: disposing an insulated layer on junctions of the touch electrodes and the upper metal paths, the insulated layer reserving a plurality of electrical connecting holes.

An insulated layer is disposed on junctions of the touch electrodes and the upper metal paths within the non-touch area. A plurality of electrical connecting holes is reserved on the insulated layer corresponding to the junctions of the touch electrodes and the upper metal paths. The insulated layer is formed via screen printing or lithography. The dielectric constant of the insulated layer material ranges from 2 to 4 and a translucent insulated material can be used, such as ink, or a non-translucent material can be used. The above materials can be either organic or inorganic. The inorganic material is selected from the group consisting of silicon oxide, silicon nitride, silicon oxynitride, silicon carbide, hafnium oxide, and aluminum oxide. The organic material is selected from the group consisting of photo resist, benzocyclobutene, ring vinyl, polyester, polyalcohol, polyethylene oxide, polyphenylene, resin, polyether, and polyketide.

S9: disposing a lower metal path layer having a plurality of lower metal paths on the insulated layer, electrically connecting the upper metal paths and the touch electrodes via the electrical connecting holes, and electrically connecting the upper metal paths and the lower metal paths via electrical connecting holes.

Via either silver paste printing or sputtering, a lower metal path layer is disposed on the insulated layer; simultaneously, the touch electrodes are electrically connected to the lower metal paths via the reserved electrical connecting holes. Also, the upper metal paths are electrically connected to the lower metal paths. The above metal path layers can be formed via either silver paste printing or sputtering.

S10: disposing a passivation layer on the touch electrode layer, the lower metal path layer, and the insulated layer.

On the touch electrode layer, the lower metal path layer, and the insulated layer, a passivation is formed via coating to protect the touch electrode layer, the lower metal path layer, and the insulated layer.

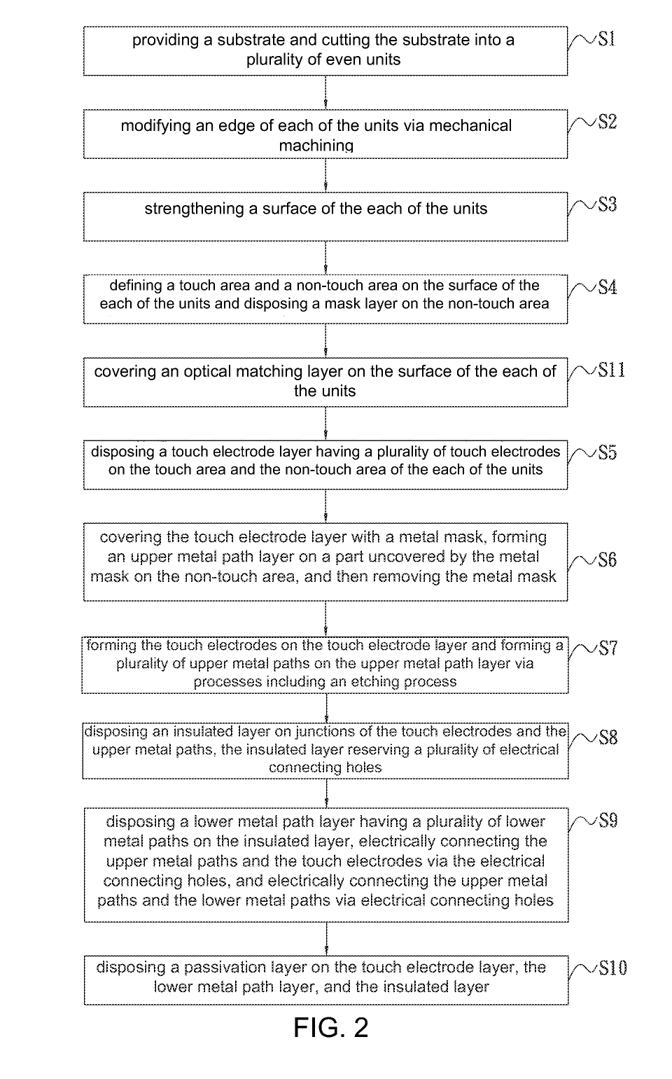

Please refer to FIG. 2, which is a manufacturing process of the method of manufacturing touch devices according to the second embodiment of the present invention. As shown in FIG. 2, the method of manufacturing the touch devices comprises the steps of:

S1: providing a substrate and cutting the substrate into a plurality of even units.

S2: modifying an edge of each of the units via mechanical machining.

S3: strengthening a surface of the each of the units.

S4: defining a touch area and a non-touch area on the surface of the each of the units and disposing a mask layer on the non-touch area.

S5: disposing a touch electrode layer having a plurality of touch electrodes on the touch area and the non-touch area of the each of the units.

S6: covering the touch electrode layer with a metal mask, forming an upper metal path layer on a part uncovered by the metal mask on the non-touch area, and then removing the metal mask.

S7: forming the touch electrodes on the touch electrode layer and forming a plurality of upper metal paths on the upper metal path layer via processes including an etching process.

S8: disposing an insulated layer on junctions of the touch electrodes and the upper metal paths, the insulated layer reserving a plurality of electrical connecting holes.

S9: disposing a lower metal path layer having a plurality of lower metal paths on the insulated layer, electrically connecting the upper metal paths and the touch electrodes via the electrical connecting holes, and electrically connecting the upper metal paths and the lower metal paths via electrical connecting holes.

S10: disposing a passivation layer on the touch electrode layer, the lower metal path layer, and the insulated layer.

The manufacturing processes of the second embodiment are the same as part of the manufacturing processes of the first embodiment and will not be explained again here. The only difference between these two embodiments is that the second embodiment further comprises the step (S11) of covering an optical matching layer on the surface of the each of the units between the step (S4) of defining the touch area and the non-touch area on the surface of the each of the units and disposing the mask layer on the non-touch area and the step (S5) of disposing the touch electrode layer having the touch electrodes on the touch area and the non-touch area of the each of the units.

By means of the method of manufacturing the touch devices of the present invention, the manufacturing time can be significantly reduced and the use of the masks is decreased, further lowering the whole manufacturing cost.

Besides, the large-sized substrate is first cut into a plurality of even units such that the grinding machining can be performed on the edges of the cut units to enhance the structure strength of the units.

What is claimed is:

1. A method of manufacturing touch devices, including the steps of:
providing a substrate and cutting the substrate into a plurality of even units;
modifying an edge of each of the units via mechanical machining;
strengthening a surface of the each of the units;
defining a touch area and a non-touch area on the surface of the each of the units and disposing a mask layer on the non-touch area;
disposing a touch electrode layer having a plurality of touch electrodes on the touch area and the non-touch area of the each of the units;
covering the touch electrode layer with a metal mask, forming an upper metal path layer on a part uncovered by the metal mask on the non-touch area, and then removing the metal mask;
forming the touch electrodes on the touch electrode layer and forming a plurality of upper metal paths on the upper metal path layer via processes including an etching process;
disposing an insulated layer on junctions of the touch electrodes and the upper metal paths, the insulated layer reserving a plurality of electrical connecting holes;
disposing a lower metal path layer having a plurality of lower metal paths on the insulated layer, electrically connecting the upper metal paths and the touch electrodes via the electrical connecting holes, and electrically connecting the upper metal paths and the lower metal paths via electrical connecting holes; and
disposing a passivation layer on the touch electrode layer, the lower metal path layer, and the insulated layer.

2. The method of manufacturing the touch devices according to claim 1, wherein the mechanical machining is grinding machining performed on the edge of the each of the units.

3. The method of manufacturing the touch devices according to claim 1, further comprising the step of covering an optical matching layer on the surface of the each of the units between the step of defining the touch area and the non-touch area on the surface of the each of the units and disposing the mask layer on the non-touch area and the step of disposing the touch electrode layer having the touch electrodes on the touch area and the non-touch area of the each of the units.

4. The method of manufacturing the touch devices according to claim 1, wherein the size of each of the even units ranges from 7 inches to 13.3 inches.

5. The method of manufacturing the touch devices according to claim 1, wherein the touch electrode layer is formed via sputtering.

6. The method of manufacturing the touch devices according to claim 1, wherein the mask layer is formed via ink coating.

7. The method of manufacturing the touch devices according to claim 1, wherein the touch electrode layer is selected from the group consisting of indium tin oxide, indium zinc oxide, zinc indium tin oxide, hafnium oxide, zinc oxide, aluminum oxide, aluminum tin oxide, aluminum tin oxide, cadmium tin oxide, and cadmium zinc cadmium oxide.

8. The method of manufacturing the touch devices according to claim 1, wherein the insulated layer is formed via screen printing or lithography.

9. The method of manufacturing the touch devices according to claim 1, wherein the passivation layer is either inorganic material or organic material.

10. The method of manufacturing the touch devices according to claim 10, wherein the inorganic material is selected from the group consisting of silicon oxide, silicon nitride, silicon oxynitride, silicon carbide, hafnium oxide, and aluminum oxide, wherein the organic material is selected from the group consisting of photo resist, benzocyclobutene, ring vinyl, polyester, polyalcohol, polyethylene oxide, polyphenylene, resin, polyether, and polyketide.

11. The method of manufacturing the touch devices according to claim 1, wherein the insulated layer is either inorganic material or organic material.

12. The method of manufacturing the touch devices according to claim 11, wherein the inorganic material is selected from the group consisting of silicon oxide, silicon nitride, silicon oxynitride, silicon carbide, hafnium oxide, and aluminum oxide, wherein the organic material is selected from the group consisting of photo resist, benzocyclobutene, ring vinyl, polyester, polyalcohols, polyethylene oxide, polyphenylene, resin, polyether, and polyketide.

13. The method of manufacturing the touch devices according to claim 1, wherein in the etching process, the etchant for the touch electrode layer is selected from the group consisting of nitric acid, hydrochloric acid, and water, the etchant for the metal path layers is selected from the group consisting of phosphate, nitric acid, acetic acid, and water.

14. The method of manufacturing the touch devices according to claim 1, wherein the upper and lower metal path layers are formed via either silver paste printing or sputtering.
